(19) United States
(12) Patent Application Publication
(10) Pub. No.: US 2010/0227655 A1
(43) Pub. Date: Sep. 9, 2010

(54) FOLDING-TYPE PORTABLE ELECTRONIC DEVICE

(75) Inventor: Arisa Takabayashi, Yokohama-shi (JP)

Correspondence Address: Seed Intellectual Property Law Group PLLC, 701 Fifth Avenue, Suite 5400, Seattle, WA, 98104, US

(73) Assignee: PANASONIC CORPORATION, Kadoma-shi, Osaka (JP)

(21) Appl. No.: 12/677,500

(22) PCT Filed: Jun. 29, 2009
(86) PCT No.: PCT/JP2009/002999

§ 371 Date: Mar. 10, 2010

(30) Foreign Application Priority Data
Oct. 20, 2008 (JP) 2008-269701

(51) Int. Cl. H04M 1/00

(52) U.S. Cl. 455/575.3

(57) ABSTRACT

In a folding-type portable electronic device, a hinge has a structure of: that a rotating portion rotates along with a first enclosure around a rotational axis while the first enclosure is opened with respect to a second enclosure; that a part of the rotating portion of the hinge is disposed outside on at least one of side ends of the first enclosure; and that the rotational axis of the hinge is located on an extension of a base end of the second enclosure close to the hinge in both states where the enclosures are opened or closed. In the second enclosure, an end face of a base opposing the rotating portion is formed along an outer periphery of the rotating portion, and a projection projecting to the outside of the second side of the second enclosure opposite to its operation section is formed along an angular edge of the base.

### TECHNICAL FIELD

The present invention relates to a folding-type portable electronic device having a hinge for openably and closably joining enclosures.

### BACKGROUND ART

A hitherto available portable electronic device, such as a portable phone, includes a folding-type portable electronic device having an enclosure structure that is openable and closable by means of a hinge. A common structure for the portable electronic device of this type has a first enclosure equipped with a main display section, a second enclosure equipped with a main operation section, and a hinge for rotatably joining the first enclosure and the second enclosure. Two enclosures are opened and closed by rotating action of the hinge.

In the folding-type portable electronic device, assuming a second enclosure equipped with a main operation section that is gripped and operated by a user being taken as a reference, the structure of a hinge includes one structure in which only an interior hinge member rotates during opening and closing action of enclosures and in which both exterior hinge members are stationary (both exterior hinges are provided integrally on a second enclosure) and another structure in which one or both of the exterior hinge members rotate (one or both of the exterior hinges are provided integrally on the first enclosure). In the case of a structure in which at least one of the exterior hinge members is rotated at the time of opening and closing of the enclosures while the user grips the second enclosure, there is a potential risk of a finger being nipped between the hinge, which rotates when the enclosures are opened, and an end of the second enclosure.

Patent Literature 1 (JP-A-2008-187285) describes a folding-type portable terminal device having a rib provided on the outside of a side surface of the second enclosure as an example structure in which at least one of exterior hinge members is rotated with respect to the second enclosure having the main operation section, such as that mentioned above. Patent Literature 2 (JP-A-11-88483) describes a simplified portable phone having an open-close cover provided to be openable and closable with respect to a phone main body.

### Citation List

### Patent Literature(s)

Patent Literature 1: JP-A-2008-187285 (FIG. 1)

Patent Literature 2: JP-A-11-88483 (FIG. 1)

### SUMMARY OF INVENTION

### Technical Problem that Invention is to Solve

Patent Literature 1 provides a structure equipped with ribs for enabling easy performance of opening operation. However, no consideration is given to a potential risk of a user's finger being nipped at the time of opening of the enclosures and a hindrance to rotating action of the enclosures. In Patent Literature 2, since an axis of the hinge is located on the first enclosure, the user's finger is not nipped by a rotating portion of the hinge, which in rotate prevents occurrence of a failure, such as nipping of a finger or a hindrance to rotating action of the enclosure. However, when the first enclosure is viewed from above while the enclosures are closed, the hinge and an exterior surface of the first enclosure are separated from each other (they are not flush with each other), and a design performance of the electronic device is deteriorated as compared with a case where the axis of the hinge is provided on the second enclosure side.

The present invention has been conceived in view of the circumstance and aims at providing a folding-type portable electronic device that can prevent occurrence of nipping of a user's finger while realizing an enhanced design performance in connection with a structure in which at least one of exterior hinges rotates with respect to a second enclosure having a main operation section.

### Solution to Problem

The present invention provides a folding-type portable electronic device including: a first enclosure provided with a main display section; a second enclosure provided with a main operation section; and a hinge that openably and closably joins the first enclosure to the second enclosure, wherein the hinge has a structure of: that a rotating portion rotates along with the first enclosure around a rotational axis when the first enclosure is opened with respect to the second enclosure; that a part of the rotating portion of the hinge is disposed at an end of the first enclosure in a lateral direction; and that the rotational axis of the hinge is located on an extension of a longitudinal side surface of the second enclosure in both states where the first enclosure and the second enclosure are opened and closed, and wherein a surface of the second enclosure facing the rotating portion is formed along an outer periphery of the rotating portion.

By means of the configuration, in connection with structure in which at least one exterior hinge member rotates with respect to the second enclosure having a main operation section, when the rotational axis of the hinge is located on the extension of the longitudinal side surface of the second enclosure in both states where the first enclosure and the second enclosure are opened and closed, occurrence of a failure, such as nipping of a user's finger by a portion of the rotating portion serving as the exterior hinge member, can be prevented.

The present invention includes a configuration in the folding-type portable electronic device, wherein a portion of the rotating portion of the hinge opposing the second enclosure is formed into an elliptic columnar shape, and the surface of the second enclosure opposing the rotating portion is formed into a recessed, elliptic-arc shape extending along a rotational path of the rotating portion.

By means of the configuration, it is possible to minimize clearance between the rotating portion of the hinge and the base of the second enclosure close to the hinge, thereby preventing nipping of the finger, which would otherwise arise when the enclosures are opened.

The present invention includes a configuration in the folding-type portable electronic device, wherein a projection, having a contact face that the rotating portion contacts when the first enclosure is opened, is formed on a second side of the second enclosure opposite to a first side where the main operation section is provided.

By means of the configuration, it is possible to provide the projection with a hinge stopper function and a finger stopper function, so that an effect of preventing nipping of a finger can be enhanced further.

The present invention includes a configuration in the folding-type portable electronic device, wherein the contact surface of the projection is provided in an extension of a radial line passing through an axis center of the rotational axis of the hinge in the rotating portion.

By means of the configuration, it is possible to enhance strength of the projection achieved when receiving the rotating action of the hinge.

The present invention includes a configuration in the folding-type portable electronic device, wherein the projection is formed from a camera unit provided so as to protrude from the second side of the second enclosure.

The present invention includes a configuration in the folding-type portable electronic device, wherein the projection is formed from a speaker unit provided so as to protrude from the second side of the second enclosure.

By means of the configuration, it is possible to implement a hinge stopper function and a finger stopper function by forming a projection on a camera unit, a speaker unit, or the like.

### ADVANTAGEOUS EFFECTS OF INVENTION

The present invention enables provision of a folding-type portable electronic device that can prevent occurrence of a failure, such as nipping of a user's finger, while realizing an enhanced design performance in connection with a structure in which at least one of exterior hinge members rotates with respect to a second enclosure having a main operation section.

### BRIEF DESCRIPTION OF DRAWINGS

FIG. 1 is a perspective view showing an exterior configuration of a folding-type portable electronic device according to an embodiment of the present invention, wherein (A) is a perspective view of the portable electronic device achieved when enclosures are opened and viewed from the front, and (B) is a perspective view of the folding-type portable electronic device achieved when viewed from a back of the portable electronic device.

FIG. 2 is a side view of the folding-type portable electronic device according to the embodiment, wherein (A) shows one side of the electronic device achieved when the enclosures are opened, and (B) shows the other side of the same.

FIG. 3 is an enlarged side view showing a rotating state of a hinge in the folding-type portable electronic device according to the present embodiment, wherein (A) shows a closed state of the enclosures, (B) shows the enclosures opened to an angle of 45°, and (C) shows the enclosures opened to 90°.

FIG. 4 is an enlarged side view showing a rotating state of the hinge in the folding-type portable electronic device according to the present embodiment, wherein (A) shows a state in which the enclosures are opened to 120°, and (B) shows a state in which the enclosures are opened to a fully-opened position.

FIG. 5 is a side view showing the configuration of a hinge of a first exemplary modification of the embodiment.

FIG. 6 is a side view showing the configuration of a hinge of a second exemplary modification of the embodiment.

### DESCRIPTION OF EMBODIMENTS

The following embodiment shows an example configuration of a folding-type portable electronic device achieved when the present invention is applied to a portable terminal device, such as a portable phone. The present invention is applicable to various electronic devices that can be carried while gripped with a user's hand.

### Embodiment

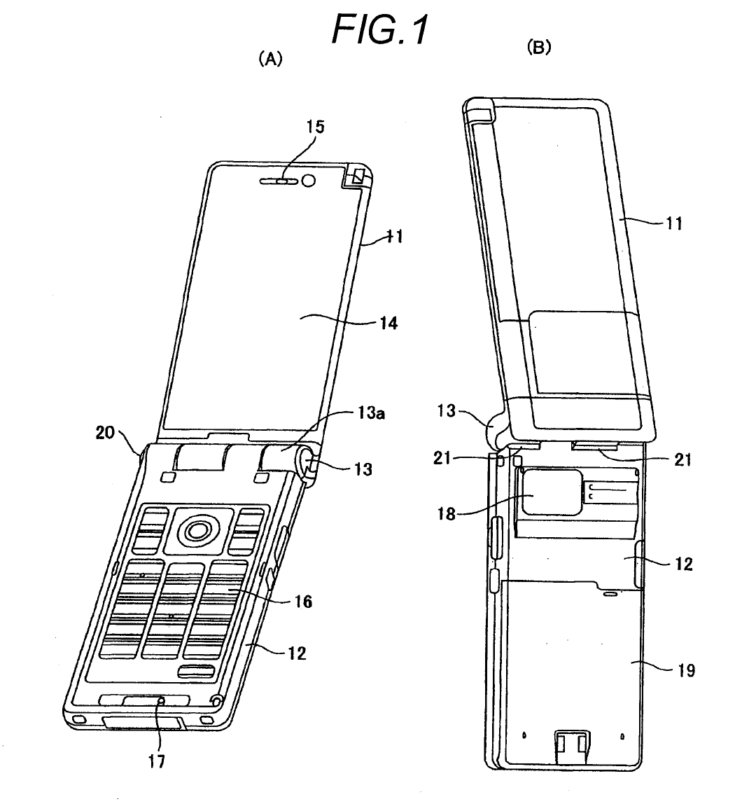

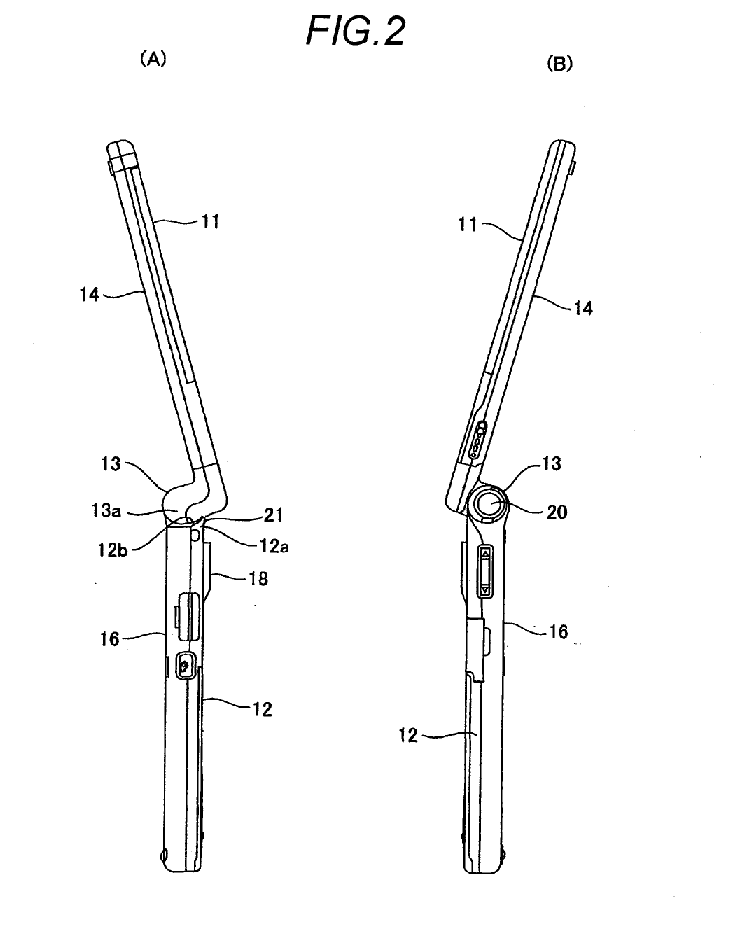

FIG. 1 is a perspective view showing an exterior configuration of a folding-type portable electronic device according to an embodiment of the present invention. In FIG. 1, (A) is a perspective view of the folding-type portable electronic device when viewed from the front on which a display section and an operation section are disposed in an open state of enclosures, and in FIG. 1, (B) is a perspective view of the folding-type portable electronic device when viewed from the back in the open state of enclosures. FIG. 2 is a side view of the folding-type portable electronic device of the embodiment, wherein in FIG. 2, (A) shows one side of the electronic device with the enclosures open, and in FIG. 2, (B) shows the other side of the same with the enclosures open.

The portable electronic device of the present embodiment includes a thin, substantially-parallelepiped or plate-shaped first enclosure 11 and a thin, substantially-parallelepiped or plate-shaped second enclosure 12. The portable electronic device has a folding structure in which one end of the first enclosure 11 and one end of the second enclosure 12 are rotatably joined by a hinge 13. The portable electronic device performs rotating action around an axis of the hinge 13, whereby the enclosures are opened or closed.

A display section 14 serving as a main display section and a receiver 15 that outputs speech sound in a phone function mode are provided on a front side of the first enclosure 11 that serves as an inside when the enclosures are closed (the front side is hereinafter called a “first side”). The display section 14 includes a display device, such as an LCD and an organic EL display. The display section displays, on a display screen, an operational status of the electronic device, indications of respective functions, a menu display, a standby display, and the like.

The second enclosure 12 has, on the first side that serves as an inside side when the enclosures are closed, an operation section 16 serving as a main operation section and a microphone 17 that enables inputting of speech sound in the phone function mode. The operation section 16 includes a plurality of push buttons such as a numeric key pad and an operation input device such as a four-way operation key, and enables the user to input operations corresponding to respective actions. The second enclosure 12 has a camera unit 18 and a battery pack 19 provided on a back side that serves as an outside when the enclosures are closed (the back side is hereinafter called a “second side”).

The hinge 13 has a structure divided into four segments when viewed from the front. A member on the right end and a third member from the right in (A) of FIG. 1 are provided integrally on the first enclosure 11, and a second member from the right and a member on the left end are provided integrally on the second enclosure 12. Therefore, when the user opens and closes the enclosure while gripping the second enclosure 12, the first enclosure 11 is rotated with respect to the second enclosure 12. Hence, the member on the right end and the third member from the right in (A) of FIG. 1 act as a hinge rotating portion and rotate along with the first enclosure 11. Specifically, a part of the rotating portion of the hinge 13 is disposed at an end of the first enclosure 11 in its lateral direction and located outside at least either a right side end or a left side end. A left-end side surface of the hinge 13 shown in (A) of FIG. 1 is provided with a push button 20 to be actuated to open the enclosures. The hinge 13 has a so-called one-push open mechanism. As a result of the push button 20 being pressed, the enclosures are rotated in a direction of opening under its force stemming from a spring, or the like, to thus be open.

As mentioned above, the hinge 13 of the present embodiment has a structure in which one exterior rotating portion 13a rotates with respect to the second enclosure 12. The same can also be applied not only to the structure including one exterior rotating portion but also to a structure in which both exterior rotating portions of the hinge rotate with respect to the second enclosure. The hinge 13 is structured such that a axis center of the rotational axis is located on a longitudinal side surface of the second enclosure 12; namely, an extension of a hinge-side base of the second enclosure 12, in both states where the enclosures are opened and closed. Namely, the hinge-side base of the first enclosure 11 rotates and opens so as to protrude to the outside in excess of a longitudinally-extended plane of the second side of the second enclosure 12.

In such a hinge structure, a base 12a of the second enclosure 12 adjoining the hinge 13 is formed in such a way that an end face 12b opposing an exterior rotating portion 13a of the hinge 13 formed into a partial cutout of a column assumes a profile extending along a rotational path of the rotating portion 13a and a concave, circular-arc shape extending along an outer periphery of the rotating portion 13a. In an area where the rotating portion 13a of the hinge 13 and the base 12a of the second enclosure 12 oppose each other, an exterior shape of the circumference of the columnar rotating portion 13a and the profile of a corresponding circular-arc of the end face 12b of the base 12a assume the shape of an ellipse or a complete round, as illustrated. In this case, the end face 12b of the second enclosure 12 forms a curved surface that is made as closely as possible to the outermost path, which is achieved during rotating of the rotating portion 13a of the hinge 13, while assuring predetermined clearance with respect to the outermost path. By means of the configuration, the end face 12b of the base 12a of the second enclosure 12 comes into closely located at all times during rotating of the hinge 13, so that nipping of the user's finger between the rotating portion 13a of the hinge 13 and the base 12a of the second enclosure 12, which would otherwise be caused when the enclosures are opened, is prevented.

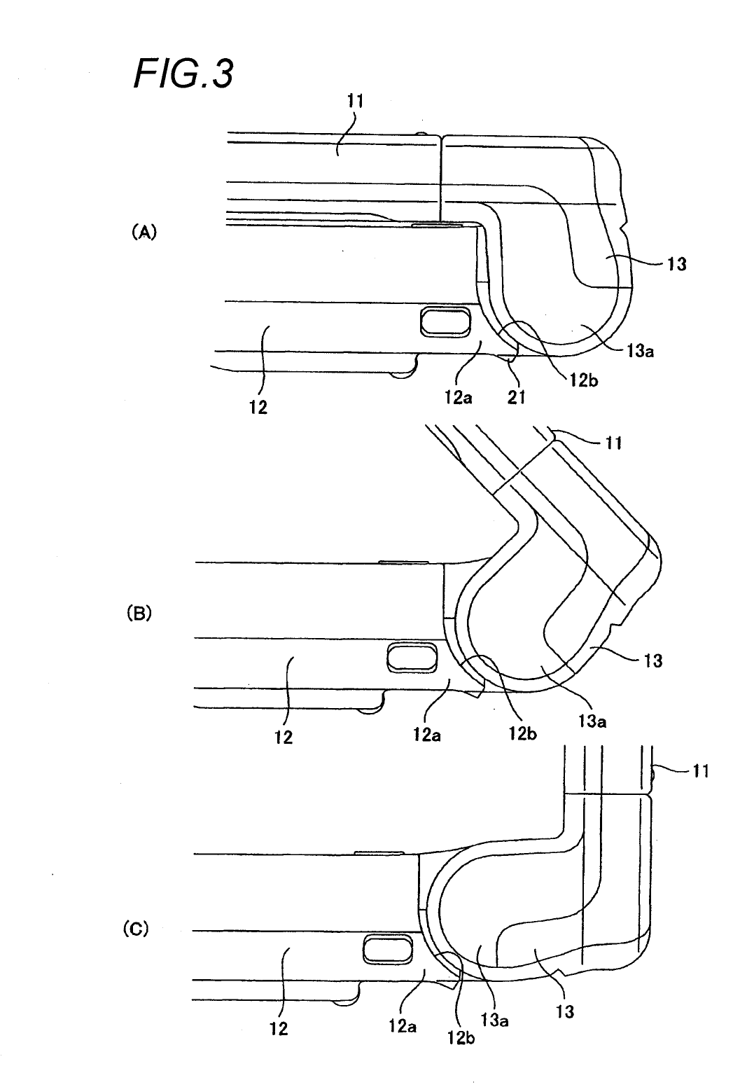

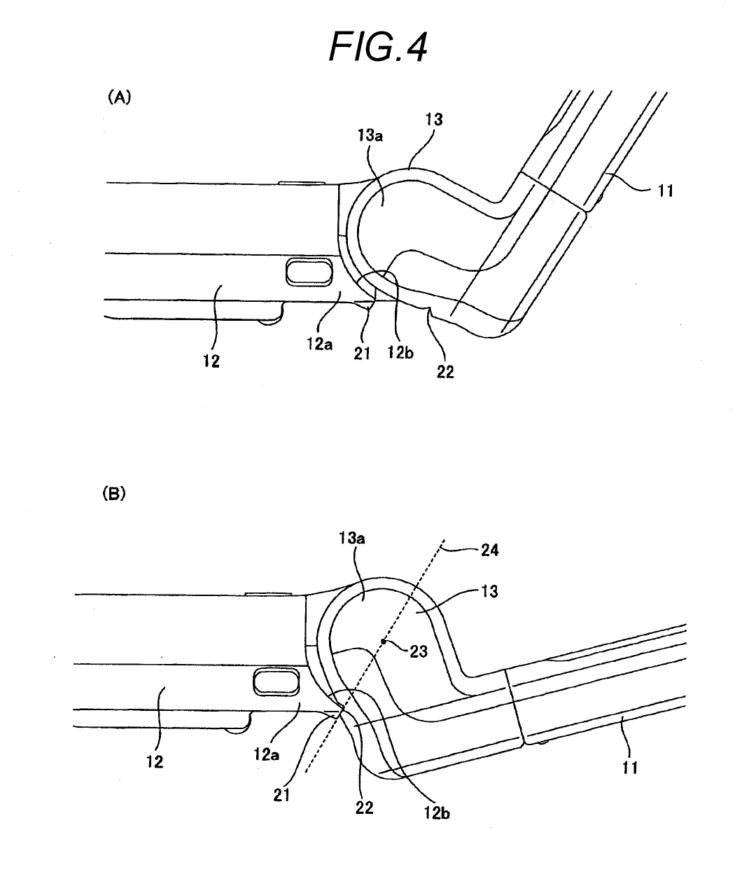

FIGS. 3 and 4 are enlarged side views showing rotating states of the hinge in the folding-type portable electronic device of the embodiment. In FIG. 3, (A) shows a closed state of the enclosures; (B) in FIG. 3 shows a state of the enclosures opened to an angle of 45°; (C) in FIG. 3 shows a state of the enclosures opened to an angle of 90°; (A) in FIG. 4 shows a state of the enclosures opened to an angle of 120°; and (B) in FIG. 4 shows a state of the enclosures opened to a fully-open position. As mentioned previously, the profile of the end face 12b of the base 12a of the second enclosure 12 is formed along the outer periphery of the rotating portion 13a. Therefore, the base 12a of the second enclosure 12 and the rotating portion 13a are located at a position where they remain close to each other at all times from when the enclosures are closed until when the enclosures are opened, and large clearance does not occur.

A rib-shaped projection 21 that projects outside from the second side of the second enclosure 12 and that assumes a triangular cross-sectional profile is formed along an angular edge of the base 12a of the second enclosure 12. Further, a triangular recess 22 is formed at a predetermined location on the outer periphery of the rotating portion 13a in correspondence with the projection 21. The projection 21 and the groove 22 exhibit the function of a hinge stopper at the time of rotating of the enclosures. The recess 22 provided in the outer periphery of the rotating portion 13a contacts the side surface of the projection 21 of the second enclosure 12 while the enclosures are fully opened, thereby holding the enclosures in the open state. The projection 21 makes it possible to hold the enclosures in an open state without fail, and the projection 21 acts as a member for restricting the position of the user's finger. Therefore, approaching of the finger toward the rotating portion 13a of the hinge 13 is prevented, so that a distance between the bulb of a finger and the rotating portion 13a can be assured. Therefore, nipping of the finger between the rotating portion 13a of the hinge 13 and the base 12a of the second enclosure 12 can be prevented without fail.

Contact surfaces between the projection 21 and the recess 22; namely, a side surface of the projection 21 and the interior surface of the recess 22, are formed so as to be located on a plane extending along a radial line 24 that passes through the axis 23 of the hinge 13. Thus, the strength of the hinge stopper achieved when the projection 21 receives rotating action of the hinge 13 can thereby be enhanced. As shown in (B) of FIG. 1, the projection 21 provided on the second enclosure 12 is arranged at least on the location where the exterior rotating portion 13a is located. Further, as another projection is additionally provided on a location where the interior rotating portion of the hinge is located, the strength of the hinge stopper can further be enhanced.

### (Exemplary Modifications)

The configuration of the hinge stopper is not limited to the projection 21 and the recess 22. There may also be realized a configuration in which the projection is provided by utilization of any of projections provided on the second side of the second enclosure 12, such as a camera unit and a speaker unit, and a lighting unit such as an LED; namely, by forming the projections to be extended, or a configuration in which the projections themselves also double as hinge stoppers. Alternatively, there may also be realized a configuration in which the projection is provided on the part of the rotating portion 13a.

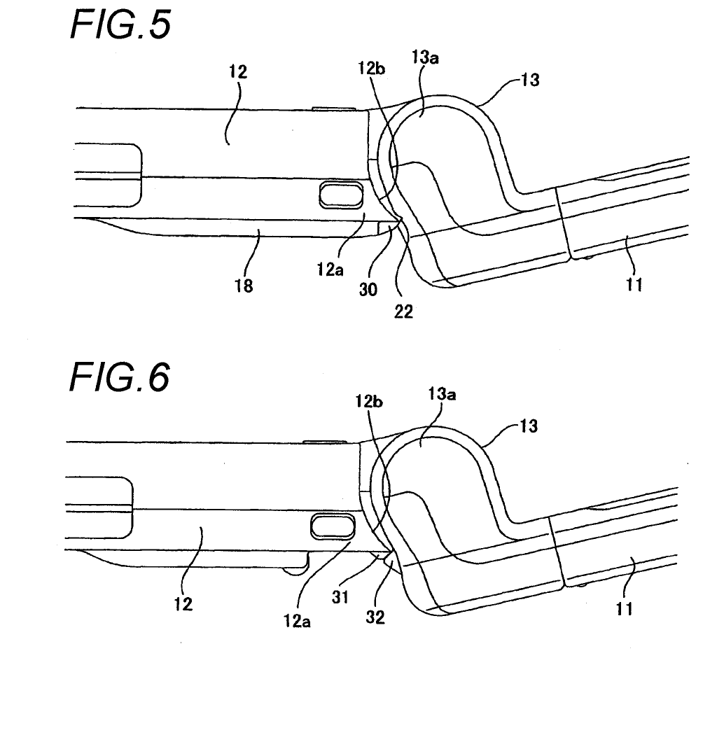

FIG. 5 is a side view showing the configuration of the hinge of a first exemplary modification of the embodiment. The first exemplary modification is an example configuration in which one end of the camera unit 18 projecting from the second side of the second enclosure 12 is let serve as a hinge stopper. In this example, one end of the camera unit 18 is formed to be extended, and an edge of the end is configured so as to serve as a projection 30 of the hinge stopper as does the projection 21 shown in (B) of FIG. 4. In a state where the enclosures are opened, the recess 22 provided on the outer periphery of the rotating portion 13a comes into contact with the side surface of the projection 30 formed from the projection of the camera unit 18, to thus be supported.

FIG. 6 is a side view showing the configuration of the hinge of a second exemplary modification of the embodiment. The second exemplary modification is an example configuration in which a projection 32 is provided, in place of the recess, on the outer periphery of the rotating portion 13a. In the example, a side surface of the projection 32 of the rotating portion 13a comes into contact with the side surface of the projection 31 provided at the angular edge of the base 12a of the second enclosure 12 while the enclosures 12 are opened, thereby serving as a hinge stopper.

Even in such exemplary modifications, a function similar to that of the hinge stopper described in connection with the embodiment shown in FIGS. 1 through 4 can be implemented.

As mentioned above, according to the embodiment, the surface of the hinge facing the rotating portion is provided with a circular-arc shape extending along the rotational path or outer shape of the rotating portion, at least at one of exterior ends of the base of the second enclosure close to the hinge. As a result, the chance of occurrence of failures, which would otherwise arise at the time of opening of the enclosures, such as nipping of the user's finger or a hindrance to rotating of the enclosures, can be obviated. A projection projecting to the outside on the second side opposite to the operation section is provided at the base of the second enclosure, whereby a configuration implementing both a hinge stopper function and a finger stopper function can be implemented, so that an effect for preventing nipping of a finger can be enhanced further.

The configuration of the embodiment corresponds to a structure in which the axis center of the rotational axis of the hinge is placed on the second enclosure; namely, a structure in which the rotational axis is located on an extension of the longitudinal side surface of the second enclosure both in the open state and the closed state and in which the base of the first enclosure close to its hinge rotates so as to project outside in excess of a plane of the second side of the second enclosure extended in the longitudinal direction, to thus open the enclosures. In terms of the structure that the exterior hinge rotating portion provided at least at one side rotates with respect to the second enclosure, the structure is more effective, so that nipping of the user's finger, which would otherwise be caused during opening of the enclosures, can be prevented without failure.

In particular, so long as the configuration of the embodiment is applied to the hinge rotating portion, which is located on the side opposite to the side surface where at least push buttons are provided, and to the base of the second enclosure corresponding to the hinge rotating portion in the hinge having a one-push opening mechanism, it is possible to prevent the enclosures from nipping the user's finger placed on the enclosure during the enclosure opening under its own force. Hence, the configuration is more effective. When both exterior hinge rotating portions are configured so as to rotate with respect to the second enclosure, the configuration of the embodiment is just applied to both sides including the side where the push buttons are to be placed.

The present invention is not limited to the embodiment provided above and is scheduled to be susceptible to alterations or modifications contrived by the skilled in the art in accordance with the descriptions of the specification and the well-known techniques, and the alterations and modifications shall fall within a range where protection of the present invention is sought.

The present patent application is based on Japanese Patent Application (Patent Application No. 2008-269701) filed on Oct. 20, 2008, the contents of which are incorporated herein by reference.

### INDUSTRIAL APPLICABILITY

The present invention yields an advantage of the ability to prevent occurrence of a failure, such as nipping of a user's finger, while a high design performance is implemented in connection with a structure in which at least one exterior hinge member rotates with respect to a second enclosure having a main operation section. The present invention is applicable to a portable terminal device, such as a portable phone, and useful as a folding-type portable electronic device, and the like, having a hinge section for openably and closably linking enclosures.

### REFERENCE SIGNS LIST

11 FIRST ENCLOSURE

12 SECOND ENCLOSURE

12a BASE

12b END FACE

13 HINGE

13a ROTATING PORTION

14 DISPLAY SECTION

16 OPERATION SECTION

18 CAMERA UNIT

20 PUSH BUTTON

21, 30, 31, 32 PROJECTION

22 RECESS

23 AXIS CENTER

1-3. (canceled)

4. A folding-type portable electronic device comprising:
a first enclosure provided with a main display section;
a second enclosure provided with a main operation section; and
a hinge that openably and closably joins the first enclosure to the second enclosure, wherein
the hinge has a structure of:
that a rotating portion rotates along with the first enclosure around a rotational axis when the first enclosure is opened with respect to the second enclosure;
that a part of the rotating portion of the hinge is disposed at an end of the first enclosure in a lateral direction; and
that the rotational axis of the hinge is located on an extension of a longitudinal side surface of the second enclosure in both states where the first enclosure and the second enclosure are opened and closed, wherein
a surface of the second enclosure facing the rotating portion is formed along an outer periphery of the rotating portion, wherein
a portion of the rotating portion of the hinge opposing the second enclosure is formed into an elliptic columnar shape, and the surface of the second enclosure opposing the rotating portion is formed into a recessed, elliptic-arc shape extending along a rotational path of the rotating portion, wherein
a projection, having a contact face that the rotating portion contacts when the first enclosure is opened, is formed on a second side of the second enclosure opposite to a first side where the main operation section is provided, and wherein
the contact surface of the projection is provided in an extension of a radial line passing through an axis center of the rotational axis of the hinge in the rotating portion.

5. A folding-type portable electronic device comprising:
a first enclosure provided with a main display section;
a second enclosure provided with a main operation section; and
a hinge that openably and closably joins the first enclosure to the second enclosure, wherein
the hinge has a structure of:
that a rotating portion rotates along with the first enclosure around a rotational axis when the first enclosure is opened with respect to the second enclosure;
that a part of the rotating portion of the hinge is disposed at an end of the first enclosure in a lateral direction; and
that the rotational axis of the hinge is located on an extension of a longitudinal side surface of the second enclosure in both states where the first enclosure and the second enclosure are opened and closed, and wherein
a surface of the second enclosure facing the rotating portion is formed along an outer periphery of the rotating portion, wherein
a portion of the rotating portion of the hinge opposing the second enclosure is formed into an elliptic columnar shape, and the surface of the second enclosure opposing the rotating portion is formed into a recessed, elliptic-arc shape extending along a rotational path of the rotating portion, wherein
a projection, having a contact face that the rotating portion contacts when the first enclosure is opened, is formed on a second side of the second enclosure opposite to a first side where the main operation section is provided, and wherein
the projection is formed from a camera unit provided so as to protrude from the second side of the second enclosure.

6. A folding-type portable electronic device comprising:
a first enclosure provided with a main display section;
a second enclosure provided with a main operation section; and
a hinge that openably and closably joins the first enclosure to the second enclosure, wherein
the hinge has a structure of:
that a rotating portion rotates along with the first enclosure around a rotational axis when the first enclosure is opened with respect to the second enclosure;
that a part of the rotating portion of the hinge is disposed at an end of the first enclosure in a lateral direction; and
that the rotational axis of the hinge is located on an extension of a longitudinal side surface of the second enclosure in both states where the first enclosure and the second enclosure are opened and closed, and wherein
a surface of the second enclosure facing the rotating portion is formed along an outer periphery of the rotating portion wherein
a portion of the rotating portion of the hinge opposing the second enclosure is formed into an elliptic columnar shape, and the surface of the second enclosure opposing the rotating portion is formed into a recessed, elliptic-arc shape extending along a rotational path of the rotating portion, wherein
a projection, having a contact face that the rotating portion contacts when the first enclosure is opened, is formed on a second side of the second enclosure opposite to a first side where the main operation section is provided, and wherein
the projection is formed from a speaker unit provided so as to protrude from the second side of the second enclosure.
